(19) United States
(12) Patent Application Publication
(10) Pub. No.: US 2023/0337131 A1
(43) Pub. Date: Oct. 19, 2023

(54) METHOD AND APPARATUS FOR ASYNCHRONOUSLY ALLOCATING RESOURCES IN MOBILE EDGE COMPUTING SYSTEM

(71) Applicant: Korea University Research and Business Foundation, Seoul (KR)

(72) Inventors: In Kyu LEE, Seoul (KR); Su Bin EOM, Daejeon (KR)

(73) Assignee: Korea University Research and Business Foundation, Seoul (KR)

(21) Appl. No.: 17/925,115

(22) PCT Filed: Jan. 25, 2021
(86) PCT No.: PCT/KR2021/000976

§ 371 Date: Apr. 19, 2023

(30) Foreign Application Priority Data
May 13, 2020 (KR) 10-2020-0057335

(51) Int. Cl. H04W 52/02

(52) U.S. Cl. CPC H04W 52/0206

(57) ABSTRACT

The present disclosure relates to a method and an apparatus for asynchronously allocating resources in a mobile edge computing (MEC) system. A method for asynchronously allocating resources in a base station of an MEC system, according to one embodiment of the present disclosure, may comprise the steps of: determining the optimal value of a predetermined variable for energy consumption minimization of the MEC system for a predetermined time period by using basic information about each of the base station, a server, and one or more terminals; transmitting configuration information about the optimal value to each of the server and the one or more terminals; and allocating a resource to each of the base station, the server, and the one or more terminals on the basis of the optimal value. Herein, the predetermined variable can include one or more from among a transmission power variable (P), a resource allocation ratio variable (W), a time duration length variable (T), and an offload-residual data partition variable (O).

### TECHNICAL FIELD

The present disclosure relates to a mobile edge computing system, and in more detail, relates to a method and an apparatus for asynchronously allocating resources in a mobile edge computing system.

### BACKGROUND ART

A mobile edge computing (MEC) system is a system that supports collaboration between communication and computing by equipping a network edge node (e.g., a base station) with a computing server. For example, in a MEC system, instead of processing all computationally intensive applications in a terminal itself, a server may perform processing instead by transmitting all or part of processing to a server and provide a result to a terminal. A data or task offloading method of such a MEC system has been recently spotlighted as a means to overcome small computing power and short battery life of IoT (Internet-of-Things) terminals.

The processing procedures of a MEC system may be largely divided into three steps. A first step is a step in which a terminal uploads all or part of tasks to be processed to a MEC server through a base station, which may be referred to as an uplink step. A second step is a step in which a MEC server processes a task uploaded from a terminal, which may be referred to as a computing step. A third step is a step in which a result calculated in a MEC server is transmitted to a terminal through a base station, which may be referred to as a downlink step. If such a MEC system is used, a calculation load is reduced in a terminal which is relatively sensitive to battery life, which may reduce energy consumption as a whole.

A variety of studies are being conducted to minimize energy consumption in a MEC system. For energy consumption minimization of a traditional MEC system, research has been conducted on the assumption of synchronous resource allocation that each of MEC system processing procedures, an uplink step, a computing step and a downlink step, is performed simultaneously for all terminals and each step has temporal orthogonality each other. Such synchronous resource allocation has a problem that all resources in a MEC system are inefficiently utilized, so additional performance improvement of a MEC system may be considered by asynchronous resource allocation. But, a method in which energy consumption is minimized by assuming asynchronous resource allocation of a MEC system has not yet been prepared.

### DISCLOSURE

### Technical Problem

A technical problem of the present disclosure is to provide an asynchronous resource allocation method and device of a mobile edge computing (MEC) system.

An additional technical problem of the present disclosure is to provide a method and a device of minimizing total energy consumption of a MEC system supporting asynchronous resource allocation.

An additional technical problem of the present disclosure is to provide a method and a device of optimizing at least one of base station transmit power, terminal transmit power, a frequency resource, a time resource and an upload data size in a MEC system supporting asynchronous resource allocation.

The technical objects to be achieved by the present disclosure are not limited to the above-described technical objects, and other technical objects which are not described herein will be clearly understood by those skilled in the pertinent art from the following description.

### Technical Solution

An asynchronous resource allocation method in a base station of a mobile edge computing (MEC) system according to an aspect of the present disclosure may include determining an optimal value of a predetermined variable for minimizing consumption energy of the MEC system for a predetermined time duration by using basic information on each of the base station, a server and at least one terminal; transmitting configuration information on the optimal value to each of the server and the at least one terminal; and allocating a resource for each of the base station, the server and the at least one terminal based on the optimal value. Here, the predetermined variable may include at least one of transmit power variable P, resource allocation ratio variable W, time duration length variable T, and offload-residual data partition variable O.

A base station device which performs asynchronous resource allocation in a mobile edge computing (MEC) system according to an additional aspect of the present disclosure may include a transceiver; a memory; and a processor. The processor may be configured to determine an optimal value of a predetermined variable for minimizing consumption energy of the MEC system for a predetermined time duration by using basic information on each of the base station, a server and at least one terminal stored in the memory; transmit configuration information on the optimal value to each of the server and the at least one terminal through the transceiver; and allocate a resource for each of the base station, the server and the at least one terminal based on the optimal value. Here, the predetermined variable may include at least one of transmit power variable P, resource allocation ratio variable W, time duration length variable T, and offload-residual data partition variable O.

The characteristics which are simply summarized above for the present disclosure are just an illustrative aspect of a detailed description of the after-described present disclosure and do not limit a scope of the present disclosure.

### Technical Effects

According to the present disclosure, an asynchronous resource allocation method and device of a mobile edge computing (MEC) system may be provided.

According to the present disclosure, a method and a device of minimizing total energy consumption of a MEC system supporting asynchronous resource allocation may be provided.

According to the present disclosure, a method and a device of optimizing at least one of base station transmit power, terminal transmit power, a frequency resource, a time resource and an upload data size in a MEC system supporting asynchronous resource allocation may be provided.

Effects achievable by the present disclosure are not limited to the above-described effects, and other effects which are not described herein may be clearly understood by those skilled in the pertinent art from the following description.

### DESCRIPTION OF DIAGRAMS

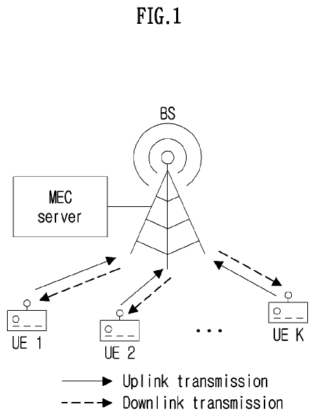

FIG. 1 is a diagram for describing a structure of a mobile edge computing (MEC) system to which the present disclosure may be applied.

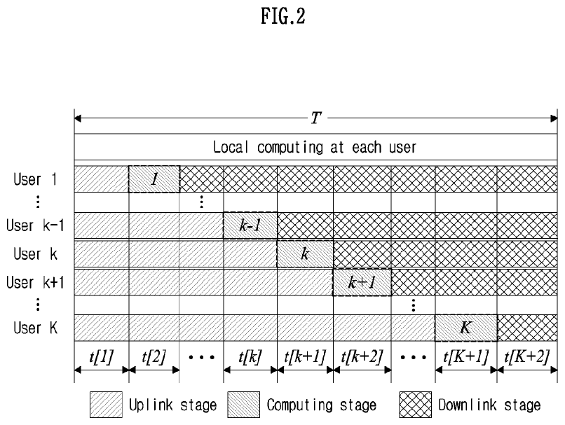

FIG. 2 is a diagram for describing an example on an asynchronous processing procedure of a MEC system to which the present disclosure may be applied.

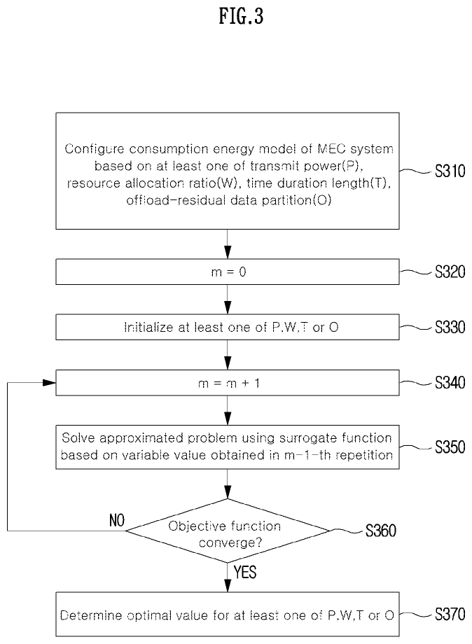

FIG. 3 is a flow chart representing a method of finding an optimal value of relative variables for the purpose of minimizing energy consumption of a MEC system to which the present disclosure may be applied.

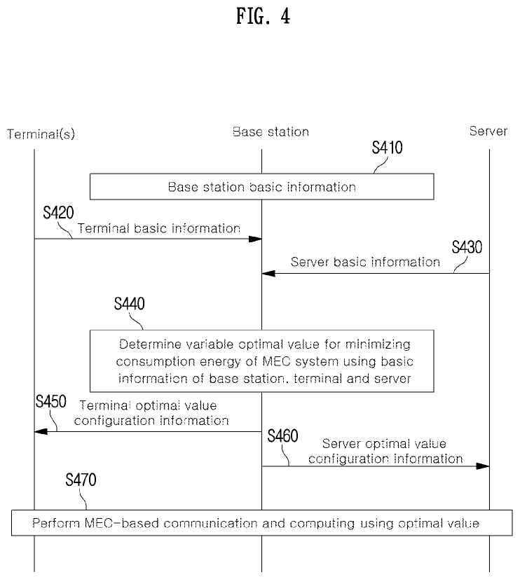

FIG. 4 is a diagram representing an example on a communication and computing method of a MEC system to which the present disclosure may be applied.

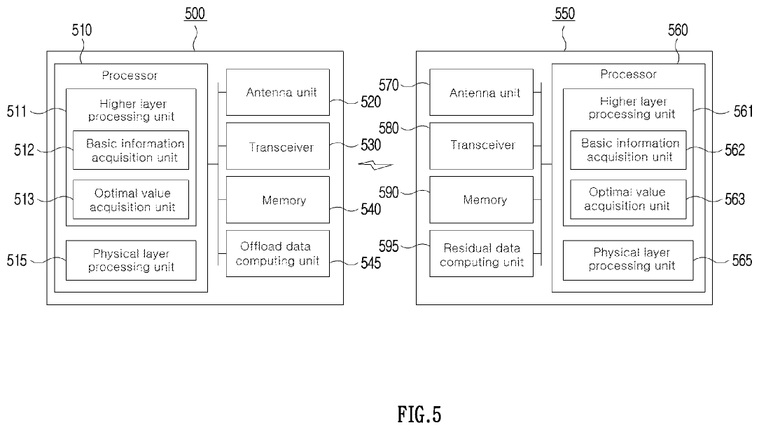

FIG. 5 is a diagram representing a configuration of a base station device and a terminal device according to the present disclosure.

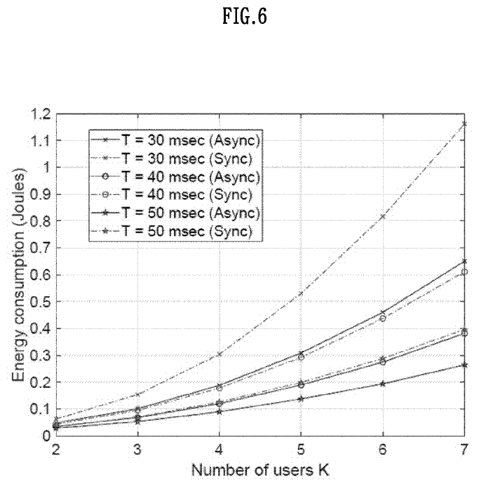

FIG. 6 is a graph representing energy consumption according to the number of terminals in a synchronous and asynchronous MEC system.

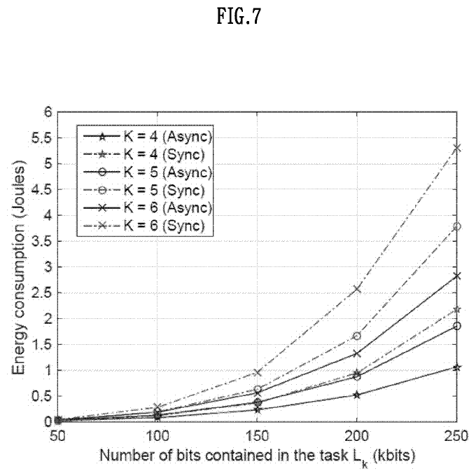

FIG. 7 is a graph representing energy consumption according to a task size to be processed in a synchronous and asynchronous MEC system.

### BEST MODE

Hereinafter, an embodiment of the present disclosure will be described in detail so that those skilled in the pertinent art from the following description can easily carry it out by referring to an attached diagram. However, the present disclosure may be implemented in a variety of different forms and is not limited to an embodiment which is described herein.

In describing an embodiment of the present disclosure, when it is determined that a detailed description on a disclosure configuration or function could cloud a gist of the present disclosure, a detailed description thereon is omitted. In addition, a part irrelevant to a description on the present disclosure in a diagram is omitted and a similar diagram code is attached to a similar part.

In the present disclosure, when an element is referred to as being “connected”, “combined” or “linked” to another element, it may include an indirect connection relation that yet another element presents therebetween as well as a direct connection relation. In addition, when an element is referred to as “including” or “having” another element, it means that another element may be additionally included without excluding another element unless otherwise specified.

In the present disclosure, a term such as first, second, etc. is used only to distinguish one element from other element and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

In the present disclosure, elements which are distinguished each other are to clearly describe each characteristic and do not mean that elements must be separated. In other words, a plurality of elements may be combined and configured in a unit of one hardware or software and one element may be distributed and configured in a unit of a plurality of hardware or software. Accordingly, even if separately mentioned, such a combined or distributed embodiment is also included in a scope of the present disclosure.

In the present disclosure, elements described in a variety of embodiments do not necessarily mean essential elements and some may be a selective element. Accordingly, an embodiment configured with a subset of elements described in an embodiment is also included in a scope of the present disclosure. In addition, an embodiment which additionally includes other element in elements described in a variety of embodiments is also included in a scope of the present disclosure.

The present disclosure is about a communication between network nodes in a wireless communication system. A network node may include at least one of a base station, a terminal or a relay. A term of a base station (BS) may be substituted with a term such as a fixed station, a Node B, an eNodeB (eNB), a ng-eNB, a gNodeB (gNB), an Access Point (AP), etc. A terminal may be substituted with a term such as UE (User Equipment), a MS (Mobile Station), a MSS (Mobile Subscriber Station), a SS(Subscriber Station), a non-AP station (non-AP STA), etc.

A wireless communication system may support a communication between a base station and a terminal and may support a communication between terminals. In a communication between a base station and a terminal, a downlink (DL) means a communication from a base station to a terminal. An uplink (UL) means a communication from a terminal to a base station. A communication between terminals may include a variety of communication methods or services such as D2D (Device-to-Device), V2X (Vehicle-to-everything), ProSe (Proximity Service), a sidelink communication, etc. In a communication between terminals, a terminal may be implemented in a form of a sensor node, a vehicle, a disaster alarm, etc.

In addition, the embodiments of the present disclosure may be applied to a wireless communication system including a relay or a relay node (RN). When a relay is applied to a communication between a base station and a terminal, a relay may function as a base station for a terminal and a relay may function as a terminal for a base station. Meanwhile, when a relay is applied to a communication between terminals, a relay may function as a base station for each terminal.

The present disclosure may be applied to a variety of multi access methods of a wireless communication system. For example, a multi access method may include CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, NOMA (Non-Orthogonal Multiple Access), etc. In addition, a wireless communication system to which the present disclosure may be applied may support a TDD (Time Division Duplex) method which uses a time resource that uplink and downlink communications are distinguished each other or may support a FDD (Frequency Division Duplex) method which uses frequency resources which are distinguished each other.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, embodiments of the present disclosure for asynchronous resource allocation of a mobile edge computing (MEC) system are described.

The present disclosure includes a method of minimizing energy consumption of the whole system when all or part of data or tasks of a terminal are offloaded to a server and processed in a MEC system. Here, for a processing procedure of a MEC system configured with an uplink step of uploading data to be offloaded to a server through a base station from a terminal, a computing step of processing data in a server, and a downlink step of transmitting a processing result to a terminal through a base station from a server, asynchronous resource allocation may be applied.

In a MEC system, synchronous resource allocation may be referred to as a method in which a different time resource is allocated to an uplink step, a computing step, and a downlink step, and after all terminals upload data for a time corresponding to an uplink step, a task for all terminals is processed in a server for a time corresponding to a computing step and a processing result for all terminals is transmitted for a time corresponding to a downlink step. Here, although a specific terminal uploads all tasks to be offloaded, a server may have to wait without performing computing for a task to be offloaded by a specific terminal until task upload of the remaining terminals is completed. Similarly, although a task for a specific terminal is computed in a server, a computing result for a specific terminal may not be transmitted until a task of the remaining terminals is completed.

But, data offloaded from each terminal is uncorrelated with each other, so it does not need to be simultaneously computed in a server. In addition, a computing step is performed in a server and an uplink step and a downlink step are separately performed in a communication module of a terminal and a base station, so a terminal and a base station may transmit or receive data while a task is processed in a server. In other words, unlike a synchronous resource allocation method in which tasks uploaded from all terminals are processed at the same time, in an asynchronous resource allocation method, detailed steps of a MEC processing procedure are sequentially performed for each terminal, and a detailed step of each terminal may be performed on a different time resource without being synchronized. For example, in the same one time duration, an uplink step for a first terminal, a computing step for a second terminal and a downlink step for a third terminal may be performed at the same time. Accordingly, if an asynchronous resource allocation method is applied, resources which are wasted in a synchronous resource allocation method may be utilized. In other words, compared with a synchronous resource allocation method, an asynchronous resource allocation method may promote additional performance improvement of a MEC system.

In the present disclosure, a method of minimizing total energy consumption of a MEC system is described for a case in which detailed steps of a MEC processing procedure for each of a plurality of terminals are performed asynchronously in a MEC system. Specifically, in order to minimize energy of the entire system consumed to perform a MEC processing procedure for a plurality of terminals, a method of optimizing transmit power of a base station, transmit power of a terminal, a frequency resource, a time resource, and a data size transmitted from a terminal to a server is described.

FIG. 1 is a diagram for describing a structure of a mobile edge computing (MEC) system to which the present disclosure may be applied.

A MEC system may be implemented based on a wireless communication system. For example, a MEC system may include a terminal (UE), a base station (BS) and a MEC server. As a MEC server (hereinafter, a server) is an entity which performs computing in a network edge, it may be configured as a MEC computing unit or an offload data computing unit integrated into a base station or may be configured as a separate entity from a base station. In the present disclosure, it is assumed that a server may communicate with a base station without delay or loss. For example, uplink data received from a terminal may be transmitted to a server through a base station and a result processed in a server may be transmitted to a terminal as downlink data through a base station.

One base station equipped with a server may serve a total of K terminals (UE). Each terminal may be indicated by index k (k=1, 2, 3, . . . , K). Terminal k (or a k-th terminal) may perform uplink transmission to a base station and a base station may perform downlink transmission to terminal k.

For a consumption energy model of a MEC system described later, it is assumed that each of base stations and terminals is equipped with one antenna. Of course, the present disclosure is not limited thereto, and each of base stations and terminals may have at least one antenna.

In addition, it is assumed that terminal k has task Sₖ in a Lₖ bit size. Here, a task size of each terminal may be the same or different. It is assumed that the maximum allowable delay time for processing completion of task Sₖ of terminal k is T. In addition, it is assumed that task processing for all of K terminals is completed within T times.

It is assumed that a server has higher computing power than a terminal. In addition, a server may be equipped with a computing resource such as a processor, a program, an application, etc. required to process a task and process a task requested by a terminal.

Partial offloading may be applied in which part of a terminal's task is transmitted to a server and processed in a server due to low computing power of a terminal. For example, terminal k may transmit data of l_{S,k}∈[0,Lₖ] bits (i.e., offload data) among its task Sₖ to a server and request a server to process it and process data of residual l_{L,k}=Lₖ−l_{S,k} bits (i.e., residual data) by itself by using a computing resource of a terminal.

FIG. 2 is a diagram for describing an example on an asynchronous processing procedure of a MEC system to which the present disclosure may be applied.

T, the total allowable delay time, may be partitioned into a total of K+2 time durations. Here, a length of a n(n=1, 2, 3, . . . K+2)-th time duration is referred to as t[n]. Here, a length of t[n] may be the same or different in each time duration n. In this case, the total allowable delay time and t[n] have a relationship like the following Equation 1.

$${\sum }_{n = 1}^{K + 2} t [ n ] \leq T \qquad [ Equatin 1 ]$$

In an example of FIG. 2, it is assumed that an offloading task of a corresponding terminal is processed in a server in order from terminal 1 to terminal k.

Terminal k may transmit l_{S,k} bits to a base station (or to a server through a base station) for a time duration corresponding to an uplink step. Here, an uplink duration of terminal k corresponds to a n=1, 2, . . . , k-th time duration. In this case, the number or length of uplink durations of each terminal may be different. Terminal k may perform uplink transmission by using the entire uplink duration and perform uplink transmission for part of the time. In other words, an uplink duration of terminal k refers to a time resource that uplink transmission of a corresponding terminal should be allowed or completed, and there is no limit that a corresponding terminal continuously performs uplink transmission for an uplink duration.

When an uplink duration of a different terminal overlaps, corresponding terminals may perform uplink transmission in a way of minimizing mutual interference. For example, as described later, interference of uplink transmission of a plurality of terminals may be minimized through optimization for uplink transmit power, a frequency resource allocation ratio, a time duration length or an uplink transmission data (or offload data) size of each terminal k in each time duration n.

After uplink transmission of terminal k is completed in a n=1, 2, . . . , k-th time duration, an uplink duration of terminal k, a server may process data uploaded from terminal k (i.e., offloaded task data) in a k+1-th time duration corresponding to a computing step.

After data processing for terminal k of a server is completed in a k+1-th time duration, a computing duration for terminal k, a base station may transmit a processing result of a server to terminal k for a time duration corresponding to a downlink step. Here, a downlink duration to terminal k corresponds to a n=k+2, k+3, . . . , K+2-th time duration. In this case, the number or length of downlink durations of each terminal may be different. Terminal k may perform downlink reception by using the whole downlink duration or perform downlink reception for part of the time. In other words, a downlink duration of terminal k refers to a time resource that downlink transmission to a corresponding terminal should be allowed or completed, and there is no limit that a corresponding terminal continuously performs downlink reception for a downlink duration.

When a downlink duration of a different terminal overlaps, corresponding terminals may perform downlink reception in a way of minimizing mutual interference. For example, as described later, interference of downlink reception of a plurality of terminals may be minimized through optimization for downlink transmit power, a frequency resource allocation ratio, a time duration length, etc. for each terminal k of a base station in each n-th time duration.

According to an asynchronous resource allocation method described in the present disclosure, uplink and/or downlink transmission of other terminal and a base station may be performed in a time duration when a server performs computing for offloaded data of a specific terminal. For example, in a k+1-th time duration, a computing duration for terminal k, terminal k+1, k+2, . . . , K may perform uplink transmission to a base station and a base station may perform downlink transmission to terminal 1, 2, . . . , k−1. Accordingly, a processing procedure of a MEC system for a plurality of terminals may be performed asynchronously without wasted resources.

In reference to FIG. 2, in a first time duration, terminal 1, 2, . . . , K may perform uplink transmission and terminal 1 may complete data transmission to be offloaded to a server. In a second time duration, data uploaded in terminal 1 may be processed in a server, terminal 2, 3, . . . , K may perform uplink transmission and terminal 2 may complete data transmission to be offloaded to a server for a first to second time duration. In a third time duration, a base station may perform downlink transmission for a processing result of a server to terminal 1, data uploaded in terminal 2 may be processed in a server, terminal 3, 4, . . . , K may perform uplink transmission and terminal 3 may complete data transmission to be offloaded to a server for a first to third time duration. In a fourth time duration, a base station may perform downlink transmission for a processing result of a server to each of terminal 1 and terminal 2, data uploaded in terminal 3 may be processed in a server, terminal 4, 5, . . . , K may perform uplink transmission and terminal 4 may complete data transmission to be offloaded to a server for a first to third time duration.

As such, uplink transmission and downlink transmission for a different terminal may be performed simultaneously in the same time duration. In this case, an uplink resource and a downlink resource for a different terminal may be divided into different frequency resources. In other words, an uplink and a downlink may be divided by a Frequency Division Duplex (FDD) method. Here, a ratio of a frequency bandwidth allocated for an uplink in a n-th time duration is α[n]≥0 and a ratio of a frequency bandwidth allocated for a downlink is β[n]≥0, which may have a relationship like Equation 2.

α[n]+β[n]=1,∀n [Equation 2]

Alternatively, an uplink resource and a downlink resource for a different terminal may be divided into different time resources in the same time duration. In other words, an uplink and a downlink may be divided by a Time Division Duplex (TDD) method. Here, a ratio of a time resource allocated for an uplink in a n-th time duration is α[n]≥0 and a ratio of a time resource allocated for a downlink is β[n]≥0, which may have a relationship like the Equation 2.

In addition, a Non-Orthogonal Multiple Access (NOMA) method may be applied to uplink transmission and downlink transmission. As a NOMA method is a method in which decoding is performed sequentially while excluding a signal which is decoded first and obtained from a received signal, SIC (Successive Interference Cancellation) may be utilized.

A channel gain between a base station and terminal k is expressed as hₖ and it is assumed that this value is constant for T times. Here, for hₖ=Gdₖ^{-θ}, G represents reference pathloss at a distance of 1 m, dₖ represents a distance between terminal k and a base station, and θ represents a pathloss index.

A data bit uploaded to a base station (or a server) from terminal k in a 1≤n≤k-th time duration, an uplink duration, is referred to as I_{U,k}[n], which may be expressed as in the following Equation 3.

$${I}_{U , k} [ n ] = t [ n ] B W α [ n ] {log}_{2} ( 1 + \frac{{p}_{k} [ n ] {γ}_{k}}{{\sum }_{i = n}^{k - 1} {p}_{i} [ n ] {γ}_{i} + α [ n ]} ) \qquad [ Equation 3 ]$$

In Equation 3, BW represents the total frequency bandwidth. pₖ[n] represents uplink transmit power of terminal k in time duration n. γₖ [symbol] hₖ/(BWσ²) represents an effective signal-to-noise ratio (SNR). σ² represents power of gaussian noise. In Equation 3, NOMA decoding order is considered in descending order on the assumption that an order relation of channel gains is h₁≥ . . . ≥h_{K}.

Terminal k should upload a total of l_{S,k} bits to a base station for a 1≤n≤k-th time duration, an uplink duration, so a constraint on the total bits uploaded during an uplink step may be expressed as in the following Equation 4.

$${\sum }_{n = 1}^{k} {I}_{U , k} [ n ] \geq {l}_{S , k} , ∀ k \qquad [ Equation 4 ]$$

After successfully receiving data from terminal k, a server performs calculation for l_{S,k} bits in a k+1-th time duration. The number of cycles per bit required to process an input bit in a server may be referred to as C (cycle/bit). Accordingly, a clock frequency required to calculate l_{S,k} bits in a server may be expressed as f_{S,k}=Cl_{S,k}/t[k+1]. Due to an actual limit of computing power of a server, f_{S,k} may not exceed the maximum limit, f_{S,max}, which may be expressed as in the following Equation 5.

Cl_{S,k}≤t[k+1]f_{S,max},∀k [Equation 5]

E_{S,k}, energy consumed to process l_{S,k} bits in a server, is expressed as E_{S,k}=κ_{S} (Cl_{S,k})³/t²[k+1] according to a Dynamic Voltage and Frequency Scaling (DVFS) model and here, κ_{S} is an effective capacitance constant.

A calculation result of a server for input l_{S,k} bits may be expressed as ηl_{S,k} bits and here, η represents a rate of change after calculation.

As a calculation result of a server, ηl_{S,k} bits may be transmitted to terminal k from a base station for a downlink duration. Similarly to an uplink step, a NOMA method is also applied in a downlink step and in this case, decoding order is performed in ascending order. A bit transmitted to terminal k from a base station in a k+2≤n≤K+2-th time duration, a downlink duration, is referred to as I_{D,k}[n], which may be expressed as in the following Equation 6.

$${I}_{D , k} [ n ] = t [ n ] BW β [ n ] {log}_{2} ( 1 + \frac{{q}_{k [ n ]} {γ}_{k}}{{γ}_{k} {\sum }_{i = k + 1}^{n - 2} {q}_{i} [ n ] + β [ n ]} ) \qquad [ Equation 6 ]$$

In Equation 6, qₖ[n] represents downlink transmit power of a base station for terminal k in time duration n.

A base station should download a total of ηl_{S,k} bits to terminal k for a k+2≤n≤K+2-th time duration, a downlink duration, so a constraint on the total bits downloaded during a downlink step may be expressed as in the following Equation 7.

$${\sum }_{n = k + 2}^{K + 2} {I}_{D , k} [ n ] \geq η {l}_{ℰ , k} , ∀ k \qquad [ Equation 7 ]$$

For T times when l_{S,k} bits among task data of terminal k are partially uploaded to a base station, processed in a server, and downloaded from a base station, terminal k should process the remaining l_{L,k} bits. The maximum frequency constraint on f_{L,k}=Cl_{L,k}/T, a clock frequency of a computing resource of a terminal, may be expressed as in the following Equation 8.

Cl_{L,k}≤T f_{L,max},∀k [Equation 8]

In Equation 8, f_{L,max} is the maximum allowable clock frequency of each terminal. Energy consumed in terminal k is expressed as E_{L,k}=κ_{L}(Cl_{L,k})³/T² according to a DVFS model and in this case, κ_{L} is an effective capacitance constant of each terminal.

Based on the above-described assumption, a problem for minimizing consumption energy of a MEC system may be expressed as follows.

First, in an uplink step, a computing step and a downlink step, energy consumed in a total of k terminals is referred to as ζᵤₛₑᵣ and energy consumed in a base station and a server is referred to as ζ_{BS} which may be expressed as in the following Equation 9.

$${ζ}_{user} = {\sum }_{k = 1}^{K} {E}_{L , k} + {\sum }_{k = 1}^{K} {\sum }_{n = 1}^{k} t [ n ] {p}_{k} [ n ] \qquad [ Equation 9 ]$$

$${ζ}_{BS} = {\sum }_{k = 1}^{K} {E}_{S , k} + {\sum }_{k = 1}^{K} {\sum }_{n = k + 2}^{K + 2} t [ n ] {q}_{k} [ n ]$$

In order to solve a problem of minimizing energy consumption of a MEC system, a variable to be optimized may be configured as follows for each n within T, the total allowable delay time, and each k within K, the total number of terminals.

For each n and k, a variable for a set of pₖ[n], uplink transmit power of terminal k to a base station in time duration n, and qₖ[n], downlink transmit power of a base station to terminal k in time duration n, (hereinafter, a transmit power variable) is referred to as P, which may be defined by

P [symbol] {pₖ[n],qₖ[n],∀k,n}

For each n, a variable for a set of α[n], an uplink resource allocation ratio in time duration n, and β[n], a downlink resource allocation ratio in time duration n, (hereinafter, a resource allocation ratio variable) is referred to as W, which may be defined by W [symbol] {α[n],β[n], ∀n}.

For each n, a variable for a set of t[n], a length of time duration n, (hereinafter, a time duration length variable) is referred to as T, which may be defined by T [symbol] {t[n], ∀n}.

For each k, a variable for a set of l_{L,k}, a data size processed in a terminal, and l_{S,k}, a data size processed in a server, (hereinafter, an offload-residual data partition variable) is referred to as O, which may be defined by O [symbol] {l_{L,k},l_{S,k},∀k}.

As such, by optimizing transmit power variable P, resource allocation ratio variable W, time duration length variable T, and offload-residual data partition variable O, in order to solve a problem of minimizing consumption energy of a MEC system, a consumption energy model of a MEC system may be expressed as in the following Equation 10.

$$\begin{matrix}[ Equation 10 ] & \\ \begin{matrix}( P ) \begin{matrix}min \\ P , W , T , O\end{matrix} {w}_{1} {ζ}_{user} + {w}_{2} {ζ}_{BS} \\ s . t . {\sum }_{n = 1}^{K + 2} t [ n ] \leq T , α [ n ] + β [ n ] = 1 , ∀ n\end{matrix} & ( 1 )\end{matrix}$$

$$\begin{matrix}{p}_{k [ n ]} \leq {P}_{U} , ∀ k , n , & {\sum }_{k = 1}^{K} {q}_{k} [ n ] \leq \end{matrix} {P}_{D} , ∀ n \qquad ( 2 )$$

$$\begin{matrix}{Cl}_{s , k} \leq t [ k + 1 ] {f}_{S , max} , & {Cl}_{L , k} \leq {Tf}_{L , max} ,\end{matrix} ∀ k \qquad ( 3 )$$

$$\begin{matrix}{\sum }_{n = 1}^{k} {I}_{U , k} [ n ] \geq {l}_{S , k} , & {\sum }_{n = k + 2}^{K + 2}\end{matrix} {I}_{D , k} [ n ] \geq η {l}_{S , k} , ∀ k \qquad ( 4 )$$

In Equation 10, w₁ represents a portion occupied by consumption energy of all terminals in consumption energy of the entire system (i.e., a terminal consumption energy cost weight), and w₂ represents a portion occupied by consumption energy of a base station and a server in consumption energy of the entire system (i.e., a base station and server consumption energy cost weight). Each of w₁ and w₂ may be preconfigured as a value equal to or greater than 0 and equal to or less than 1 (or greater than 0 and less than 1) and a sum of w₁ and w₂ may be configured as 1. Such a cost weight may be configured from a system modeling perspective on which of terminal consumption energy and base station and server consumption energy has a high correlation with the entire system consumption energy.

For example, generally, a base station and a server are continuously connected to power, so there are relatively few restrictions on energy consumption or survival time, etc. and a terminal cannot supply power continuously, so energy consumption is directly related to a decrease in survival time. Accordingly, it may be assumed that a portion of energy consumed in the entire MEC system which affects system performance is not the same as energy consumption in a base station and a server and energy consumption in a terminal. For example, it may be assumed that the portion is greater in energy consumption in a terminal. In this case, w₁ may be configured as a higher value than w₂. But, such a configuration is illustrative, and according to system characteristics, w₂ may be configured to be higher than w₁ or w₁ and w₂ may be configured to be equal. In other words, a problem of minimizing consumption energy of a MEC system according to the present disclosure may be configured as a problem of minimizing weighted sum energy, not minimizing simple sum energy.

In Equation 10, (1) corresponds to Equation 1 which represents a constraint on time duration length variable T, and Equation 2 which represents a constraint on resource allocation ratio variable W.

In Equation 10, (2) represents a constraint on transmit power variable P. Here, P_{U} represents each terminal's maximum transmit power for uplink transmission to a base station, and P_{D} represents a base station's maximum transmit power for downlink transmission to each terminal.

In Equation 10, (3) and (4) represent a constraint on offload-residual data partition variable O. Specifically, (3) corresponds to Equation 5 which represents a constraint on computing power of a server, and Equation 8 which represents a constraint on computing power of a terminal. In addition, (4) corresponds to Equation 4 which represents a constraint on an uplink transmission data size of a terminal, and Equation 7 which represents a constraint on a downlink transmission data size of a base station.

In Equation 10, energy of an objective function ζ_{BS} and ζᵤₛₑᵣ has non-convex characteristics, and I_{U,k}[n] and I_{D,k}[n] in (4) also have non-convex characteristics. Accordingly, a problem in Equation 10 may not directly calculate consumption energy minimization due to non-convexity. Accordingly, a Successive Convex Approximation (SCA) method for approximating a non-convex problem to a convex problem and solving it repeatedly may be applied.

According to SCA, when a specific variable value (i.e., an optimal value obtained from previous repetition) is given, a surrogate function of a concave lower limit or a convex upper limit of a non-convex function may be obtained based on that value to approximate the entire problem to a convex problem. Accordingly, repetition may be continuously performed until an objective function converges based on a variable value obtained after solving an approximated problem.

Hereinafter, approximation of a non-convex function to a convex or concave function is described.

FIG. 3 is a flow chart representing a method of finding an optimal value of relative variables for the purpose of minimizing energy consumption of a MEC system to which the present disclosure may be applied.

In S310, based on at least one of transmit power variable P, resource allocation ratio variable W, time duration length variable T, and offload-residual data partition variable O, a consumption energy model of a MEC system may be configured. For example, a consumption energy model may be expressed as a problem of a non-convex function as in Equation 10.

It is required to obtain a surrogate function of a non-convex function for approximation of a consumption energy model, and repetitive problem solving is performed until an objective function approximated by using a surrogate function converges. As a value in previous repetition is required to obtain a surrogate function, an initial value for variables may be configured when trying to solve a problem for the first time.

For it, in S320, m representing the number of repetitions may be configured as a value of 0 and in S330, at least one of variable P, W, T, or O may be initialized. Subsequently, whenever trying to solve a problem, a value of m may be increased by 1 as in S340.

Specifically, in order to transform a non-convex function in Equation 10 into a convex function or a concave function, a product of t[n], a length of a time duration, and pₖ[n], uplink transmit power, may be defined as a new variable E_{U,k}[n], which represents energy consumed for uplink transmission from terminal k to a base station in a n-th time duration. A product of t[n], a length of a time duration, and pₖ[n], downlink transmit power, may be defined as a new variable E_{D,k}[n], which represents energy consumed for downlink transmission from a base station to terminal k in a n-th time duration. A product of t[n], a length of a time duration, and α[n], an uplink resource allocation ratio, may be defined as a new variable A[n], which represents a resource which is actually used for uplink transmission in a n-th time duration. A product of t[n], a length of a time duration, and β[n], a downlink resource allocation ratio, may be defined as a new variable B[n], which represents a resource which is actually used for downlink transmission in a n-th time duration. In other words, new variables for approximation may be expressed as in the following Equation 11.

E_{U,k}[n]=t[n]pₖ[n],E_{D,k}[n]=t[n]qₖ[n],∀k,n [Equation 11]

A[n]=t[n]α[n],B[n]=t[n]β[n],∀n

A new variable defined as in Equation 11 may be modified into a convex function as in the following Equation 12 by applying it to each of ζ_{BS} energy consumed in a base station and a server, ζᵤₛₑᵣ, energy consumed in a terminal, an uplink transmission data size I_{U,k}[n], and a downlink transmission data size I_{D,k}[n] which are factors having non-convex characteristics of Equation 10.

$${ζ}_{u s e r} = {\sum }_{k = 1}^{K} {E}_{L , k} + {\sum }_{k = 1}^{K} {\sum }_{n = 1}^{k} {E}_{U , k} [ n ] , \qquad [ Equation 12 ]$$

$${ζ}_{B {S}^{=}} {\sum }_{k = 1}^{K} {E}_{S , k} + {\sum }_{k = 1}^{K} {\sum }_{n = k + 2}^{K + 2} {E}_{D , k} [ n ] ,$$

$${I}_{U , k} [ n ] = B W A [ n ] {log}_{2} ( 1 + \frac{{E}_{U , k} [ n ] {γ}_{k}}{{{\sum }_{i = n}}^{k - 1} {E}_{U , i} [ n ] {γ}_{i} + A [ n ]} ) ,$$

$${I}_{D , k} [ n ] = B W B [ n ] {log}_{2} ( 1 + \frac{{E}_{D , k} [ n ] {γ}_{k}}{{{\sum }_{i = k + 1}}^{n - 2} {E}_{D , i} [ n ] + B [ n ]} )$$

For a variable modified as in Equation 12, for each n within T, the total allowable delay time, and each k within K, the total number of terminals, a new variable may be configured as follows.

For each n and k, a variable for a set of E_{U,k}[n], energy consumed for uplink transmission from terminal k to a base station in time duration n, and E_{D,k}[n], energy consumed for downlink transmission from a base station to terminal k in time duration n, is referred to as E (hereinafter, an uplink and downlink transmission consumption energy variable), which may be defined by E [symbol] {E_{U,k}[n], E_{D,k}[n], ∀k,n}.

For each n, a variable for a set of A[n], a resource actually used for uplink transmission in time duration n, and B[n], a resource actually used for downlink transmission in time duration n, is referred to as A (hereinafter, an uplink and downlink use resource variable), which may be defined by

A [symbol] {A[n],B[n],∀n}.

In addition, I_{U,k}[n], an uplink transmission data size, and I_{D,k}[n], a downlink transmission data size, may be expressed in a form of a new function f(x,y) as in the following Equation 13.

$$f ( x , y ) {=}^{Δ} x {log}_{2} ( 1 + \frac{y}{x} ) \qquad [ Equation 13 ]$$

$${I}_{U , k} [ n ] = BWf ( A [ n ] , {\sum }_{i = n}^{k} {E}_{U , i} [ n ] {γ}_{i} ) - BWf ( A [ n ] , {\sum }_{i = n}^{k - 1} {E}_{U , i} [ n ] {γ}_{i} )$$

$${I}_{D , k} [ n ] = BWf ( B [ n ] , {γ}_{k} {{\sum }_{i = k}}^{n - 2} {E}_{D , i} [ n ] ) - BWf ( B [ n ] , {γ}_{k} {\sum }_{i = k + i}^{n - 2} {E}_{D , i} [ n ] )$$

In order to find a surrogate lower limit function of I_{U,k}[n], an uplink transmission data size, and I_{D,k}[n], a downlink transmission data size, when a value of \tilde{x} and \tilde{y} is given to a function f(x,y), a convex surrogate upper limit function g(x,y) of a function f(x,y) may be expressed as in Equation 14 through first order Taylor approximation.

$$g ( x , y \vert \tilde{x} , \tilde{y} ) {=}^{Δ} x {log}_{2} ( 1 + \frac{\tilde{y}}{\tilde{x}} ) - \frac{{log}_{2} e}{\tilde{x} + \tilde{y}} ( x \tilde{y} - \tilde{x} y ) \qquad [ Equation 14 ]$$

Next, J_{U,k}[n] may be defined based on a value obtained by multiplying E_{U,k}[n], energy consumed for uplink transmission, by γₖ, an effective SNR. In addition, J_{D,k}[n] may be defined based on a value obtained by multiplying E_{D,k}[n], energy consumed for downlink transmission, by γₖ, an effective SNR. In other words, J_{U,k}[n] corresponds to a substitution variable for expressing a part corresponding to E_{U,k}[n] and γₖ among I_{U,k}[n], an uplink transmission data size defined in the Equation 13. In addition, J_{D,k}[n] corresponds to a substitution variable for expressing a part corresponding to E_{D,k}[n] and γₖ among I_{D,k}[n], a downlink transmission data size defined in the Equation 13. Here, a value obtained from m-th repetition of variable z may be expressed as z^{(m)}. In this case, it may be expressed as

$${J}_{U , k}^{( m )} [ n ] {=}^{Δ} {\sum }_{i = n}^{k} {E}_{U , i}^{( m )} [ n ] {γ}_{i} and$$

$${J}_{D , k}^{( m )} [ n ] {=}^{Δ} {γ}_{k} {\sum }_{i = k}^{n - 2} {E}_{D , i}^{( m )} [ n ] .$$

When a value of A^{(m-1)}[n], J_{U,k-1}^{(m-1)}[n], B^{(m-1)}[n], J_{D,k+1}^{(m-1)}[n] obtained from m−1-th repetition is given by aggregating a process of the above-described Equation 13 and Equation 14, a concave surrogate lower limit function of I_{U,k}(m)[n], an uplink transmission data size, and I_{D,k}^{(m)}[n], a downlink transmission data size, may be found as Î_{U,k}^{(m)}[n] and Î_{D,k}^{(m)}[n] respectively in Equation 15 below.

I_{U,k}^{(m)}[n]≥Î_{U,k}^{(m)}[n] [symbol] BW(f(A^{(m)}[n],J_{U,k}^{(m)}[n])−g(A^{(m)}[n],J_{U,k-1}^{(m)}[n]|A^{(m-1)}[n],J_{U,k-1}^{(m-1)}[n]))

I_{D,k}^{(m)}[n]≥Î_{D,k}^{(m)}[n] [symbol] BW(f(B^{(m)}[n],J_{D,k}^{(m)}[n])−g(B^{(m)}[n],J_{D,k+1}^{(m)}[n]|B^{(m-1)}[n],J_{D,k+1}^{(m-1)}[n])) [Equation 15]

As described above in S350, an approximated problem may be solved.

Specifically, when approximated convex or concave surrogate functions for non-convex functions are applied to Equation 10, in case that values obtained from m−1-th repetition are given, a problem of Equation 10 may be expressed again as a problem of Equation 16.

$$( P ) \begin{matrix}min \\ E , A , T , O\end{matrix} {w}_{1} {ζ}_{u s e r} + {w}_{2} {ζ}_{B S} \qquad [ Equation 16 ]$$

$$s . t . {\sum }_{n = 1}^{K + 2} t [ n ] \leq T , A [ n ] + B [ n ] = t [ n ] , ∀ n ,$$

$$\begin{matrix}{E}_{U , k} [ n ] \leq t [ n ] {P}_{U} , ∀ k , n , & {E}_{D , k} [ n ] \leq t [ n ] {P}_{D} , ∀ n\end{matrix}$$

$$\begin{matrix}C {l}_{S , k} \leq t [ k + 1 ] {f}_{S , max} , & {Cl}_{L , k} \leq {Tf}_{L , max} , ∀ k\end{matrix}$$

$${\sum }_{n = 1}^{k} {\hat{I}}_{U , k}^{( m )} [ n ] \geq {l}_{S , k} , {\sum }_{n = k + 2}^{K + 2} {\hat{I}}_{D , k}^{( m )} [ n ] \geq η {l}_{S , k} , ∀ k$$

As Equation 16 is a convex problem, an optimized value for each variable (i.e., at least one of uplink and downlink transmission consumption energy variable E, uplink and downlink use resource variable A, time duration length variable T, and offload-residual data partition variable O) may be calculated by applying an optimization method of a convex function (e.g., CVX, etc.).

Here, as shown in Equation 11, E_{U,k}[n], uplink transmission consumption energy included in variable E, corresponds to a product of pₖ[n], uplink transmit power included in variable P, and t[n], a time duration length included in variable T, and E_{D,k}[n], downlink transmission consumption energy included in variable E, corresponds to a product of qₖ[n], downlink transmit power included in variable P, and t[n], a time duration length included in variable T, so an optimal value for variable P may be derived based on an optimal value for variable E.

In addition, as shown in Equation 11, A[n], an uplink transmission use resource included in variable A, corresponds to a product of α[n], an uplink resource allocation ratio included in variable W, and t[n], a time duration length included in variable T, and B[n], a downlink transmission use resource included in variable A, corresponds to a product of β[n], a downlink resource allocation ratio included in variable W, and t[n], a time duration length included in variable T, so an optimal value for variable W may be derived based on an optimal value for variable A.

In S350, a temporary optimal value for at least one of variable P, W, T, or O may be calculated by solving an approximated problem (i.e., an objective function) as in Equation 16. In other words, an optimal value of variables calculated in m-th repetition may be stored as a temporary optimal value. Here, an optimal value for variable P may be derived from an optimal value for variable E and T, and an optimal value for variable W may be derived based on variable A and T.

When an objective function does not converge in S660, a value of m is increased by 1 by returning to S340 and an approximated problem of Equation 16 is solved again based on a temporary optimal value calculated in previous repetition (i.e., m−1-th repetition) in S350, so it may be updated to a new temporary optimal value.

When an objective function converges in S360, a temporary optimal value for at least one of current variable P, W, T, or O may be determined as a final optimal value by proceeding to S370.

As such, an optimal value for at least one of variable P, W, T, or O may be calculated by repeatedly solving until an objective function of Equation 16 converges.

Such an optimal value may be determined for each time duration n and each terminal k within T, an allowable delay time duration in which MEC computing based on asynchronous offloading resource allocation of a MEC system is performed.

An optimal value of each variable obtained at a convergence point by repeatedly solving Equation 16 may be configured for a base station, a server, and terminal(s), and it may operate accordingly.

Specifically, in performing uplink transmission to a base station in each time duration n, each terminal k may determine l_{S,k}, a data size processed in a server according to an optimal value of variable O, determine t[n], a length of a n-th time duration according to an optimal value of variable T, apply pₖ[n], uplink transmit power according to an optimal value of variable P and apply α[n], an uplink resource allocation ratio according to an optimal value of variable W. In addition, a terminal may calculate data corresponding to l_{L,k}, a data size processed in a terminal according to an optimal value of variable O for a T duration.

In performing downlink transmission for each terminal k in each time duration n, a base station may determine t[n], a length of a n-th time duration according to an optimal value of variable T, apply qₖ[n], downlink transmit power according to an optimal value of variable P, and apply β[n], a downlink resource allocation ratio according to an optimal value of variable W.

In processing data offloaded from each terminal k in each time duration n, a server may determine t[n], a length of a n-th time duration according to an optimal value of variable T, and determine l_{S,k}, a data size processed in a server according to an optimal value of variable O.

FIG. 4 is a diagram representing an example on a communication and computing method of a MEC system to which the present disclosure may be applied.

In S410, a base station may obtain or determine its basic information. For example, basic information of a base station may include downlink maximum transmit power P_{D}, total frequency bandwidth BW supportable for terminal(s), calculation result change rate η, etc.

In S420, each terminal may transmit its basic information to a base station. For example, basic information of a terminal may include channel gain information according to a position of a terminal hₖ, uplink maximum transmit power P_{U}, bit size Lₖ of task Sₖ to be processed in a terminal, maximum allowable clock frequency of a terminal f f_{L,max} effective capacitance constant K_{L}, etc.

In S430, a server may transmit its basic information to a base station. For example, basic information of a server may include maximum allowable clock frequency of a server f_{S,max}, effective capacitance constant κ_{S}, etc.

In S440, a base station may determine an optimal value of variables for minimizing consumption energy of a MEC system by using basic information of a base station, terminal(s), and a server. In other words, an operation of calculating an optimal value in FIG. 3 may be performed by a base station.

For example, a base station may determine K, the number of terminals subject to asynchronous offloading data processing of a MEC system, by considering the number of terminals providing basic information of a terminal. In addition, based on hₖ, channel gain information according to a position of a terminal, an effective SNR, etc. for each terminal may be determined. In addition, a base station may determine w₁, a consumption energy cost weight of a terminal, and w₂, a consumption energy cost weight of a server. Based on it, a base station may configure a system model as in Equation 10. A configured system model may calculate an optimal value of variable P, T, W and 0 which may be transformed into an approximated objective function as in Equation 16 and may minimize consumption energy of a MEC system through repeat calculation.

A base station may determine total allowable delay time T, length of a n-th time duration t[n], downlink transmit power qₖ[n], and downlink resource allocation ratio β[n] as information configured for itself among calculated optimal values.

In S450, a base station may transmit configuration information on an optimal value to terminal(s). For example, optimal value configuration information on each terminal k may include data size to be processed in a terminal l_{L,k}, data size to be processed in a server l_{S,k}, total allowable delay time T, length of a n-th time duration t[n], uplink transmit power pₖ[n], uplink resource allocation ratio α[n], etc.

In S460, a base station may transmit configuration information on an optimal value to a server. For example, optimal value configuration information on a server may include total allowable delay time T, length of a n-th time duration t[n], data size to be processed in a server l_{S,k}, etc.

In S470, a base station, terminal(s) and a server may perform MEC-based uplink/downlink communication and computing by using each configured optimal value.

As an additional example, the above-described method of calculating an optimal value may be performed by other network node other than a base station, a server or a terminal (e.g., a network management entity). In this case, a network node may pre-obtain basic information on a base station, a server and a terminal, and may calculate an optimal value based on it and provide it to a base station, a server and a terminal.

For a method described by referring to FIG. 3 and FIG. 4, an operation of determining and/or providing an optimal value may be performed in parallel with uplink/downlink communication of a terminal and a base station and/or computing of a server. Alternatively, an optimal value may be determined and/or provided in advance before uplink/downlink communication of a terminal and a base station and/or computing of a server is performed by using basic information of a terminal, a base station and a server in advance.

FIG. 5 is a diagram which represents a configuration of a base station and a terminal according to the present disclosure.

A base station device 500 may include a processor 510, an antenna unit 520, a transceiver 530, a memory 540, and offload data computing unit 545.

A processor 510 may perform signal processing related to a baseband and include a higher layer processing unit 511 and a physical layer processing unit 515. A higher layer processing unit 511 may process an operation of a MAC layer, a RRC layer, or a higher layer or above. A physical layer processing unit 515 may process an operation of a PHY layer (e.g., downlink transmission signal processing, uplink reception signal processing, etc.). A processor 510 may control an operation of a base station device 500 in general, as well as perform signal processing related to a baseband.

An antenna unit 520 may include one or more physical antennas and support MIMO transmission and reception when including a plurality of antennas. A transceiver 530 may include a RF transmitter and a RF receiver. A memory 540 may store processed information of a processor 510, a software, an operating system, an application, etc. related to an operation of a base station device 500 and may include an element such as a buffer, etc.

An offload data computing unit 545 may perform processing for task data offloaded (or uploaded) from a terminal device 500 and transmit a result thereof to a processor 510 or a memory 540. In addition, an offload data computing unit 545 may be integrated into a base station device 500, but a scope of the present disclosure is not limited thereto and a MEC server device corresponding to an offload data computing unit 545 may be configured as a separate entity from a base station device 500. In this case, a MEC server device may be implemented to communicate with a base station device 500 without delay or loss.

A processor 510 of a base station device 500 may be configured to implement an operation of a base station in embodiments described in the present disclosure.

For example, a higher layer processing unit 511 of a processor 510 of a base station device 500 may include a basic information acquisition unit 512 and an optimal value acquisition unit 513.

A basic information acquisition unit 512 may derive basic information of a base station device 500 itself (e.g., downlink maximum transmit power P_{D}, total frequency bandwidth supportable for terminal(s) BW, calculation result change rate η, etc.) from a memory 540 or determine it based on information stored in a memory 540.

In addition, a basic information acquisition unit 512 may receive basic information of a terminal device 550 (e.g., channel gain information according to a position of a terminal hₖ, uplink maximum transmit power P_{U}, bit size Lₖ of task Sₖ to be processed in a terminal, maximum allowable clock frequency of a terminal f_{L,max} effective capacitance constant K_{L}, etc.) from a terminal device 550, or derive corresponding information which is previously received and stored in a memory 540, or determine it based on information stored in a memory 540.

In addition, a basic information acquisition unit 512 may acquire basic information of a MEC server device or an offload data computing unit 545 (e.g., maximum allowable clock frequency f_{S,max}, effective capacitance constant K_{S}, etc. of an offload data computing unit (or a MEC server device)) from an offload data computing unit 545 or a MEC server device, or derive corresponding information which is previously received and stored in a memory 540, or determine it based on information stored in a memory 540.

An optimal value acquisition unit 513 may use the above-described basic information of a base station device 500, an offload data computing unit 545 (or a MEC server device) and a terminal device 550 to derive an approximated objective function and a consumption energy model of a MEC system and determine an optimal value of a predetermined variable for minimizing consumption energy.

For example, a predetermined variable may include at least one of transmit power variable P, resource allocation ratio variable W, time duration length variable T, and offload-residual data partition variable O.

Information related to a terminal device 550 among optimal values obtained as such may be configured in a form of optimum value configuration information for a corresponding terminal device 550 and transmitted to a terminal device 550 through a physical layer processing unit 515.

Information related to a base station device 500 among optimal values obtained may be transmitted to a processor 510 and applied to uplink reception and downlink transmission. For example, a processor 500 may apply the total allowable delay time, a length of a n-th time duration, downlink transmit power, a downlink resource allocation ratio, etc.

Information related to an offload data computing unit 545 (or a MEC server device) among optimal values obtained may be transmitted to an offload data computing unit 545 (or a MEC server device) and applied for processing of data offloaded from a terminal. For example, an offload data computing unit 545 (or a MEC server device) may apply the total allowable delay time, a length of a n-th time duration, an offload data size, etc.

If a determination of an optimal value is performed by other network node (e.g., a network management entity), basic information obtained in a basic information acquisition unit 512 of a base station device 500 may be transmitted to the other network node through a physical layer processing unit 515. In this case, an optimal value acquisition unit 513 may acquire an optimal value received from the other network node.

A terminal device 550 may include a processor 560, an antenna unit 570, a transceiver 580 and a memory 590.

A processor 560 may perform signal processing related to a baseband and include a higher layer processing unit 561 and a physical layer processing unit 565. A higher layer processing unit 561 may process an operation of a MAC layer, a RRC layer, or a higher layer or above. A physical layer processing unit 565 may process an operation of a PHY layer (e.g., uplink transmission signal processing, downlink reception signal processing, etc.). A processor 560 may control an operation of a terminal device 550 in general, as well as perform signal processing related to a baseband.

An antenna unit 570 may include one or more physical antennas and support MIMO transmission and reception when including a plurality of antennas. A transceiver 580 may include a RF transmitter and a RF receiver. A memory 590 may store processed information of a processor 560, a software, an operating system, an application, etc. related to an operation of a terminal device 550 and may include an element such as a buffer, etc.

A residual data computing unit 545 may perform processing for residual data corresponding to the remaining task data excluding data offloaded (or uploaded) to an offload data computing unit 545 (or a MEC server device) of a base station device 500 among task data of a terminal device 550 and transmit a result thereof to a processor 560 or a memory 590.

A processor 560 of a terminal device 550 may be configured to implement an operation of a terminal in embodiments described in the present disclosure.

For example, a higher layer processing unit 561 of a processor 560 of a terminal device 550 may include a basic information acquisition unit 562 and an optimal value acquisition unit 563.

A basic information acquisition unit 562 may derive basic information of a terminal device 550 itself (e.g., channel gain information according to a position of a terminal hₖ, uplink maximum transmit power P_{U}, bit size Lₖ of task Sₖ to be processed in a terminal, maximum allowable clock frequency of a terminal f_{L,max}, effective capacitance constant K_{L}, etc.) from a memory 590 or determine it based on information stored in a memory 590. Basic information obtained as such may be configured in a form of terminal basic information and transmitted to a base station device 500 or other network node (e.g., a network management entity) through a physical layer processing unit 565.

An optimal value acquisition unit 563 may determine an optimal value which will be applied to a terminal device 550 based on optimal value configuration information provided from a base station device 500 or other network node.

Accordingly, a processor 560 of a terminal device 550 may apply a size of data to be processed in a terminal (i.e., residual data), a size of data to be processed in a server (i.e., offload data), the total allowable delay time, a length of a n-th time duration, uplink transmit power, an uplink resource allocation ratio, etc. based on an obtained optimal value.

In an operation of a base station device 500, an offload data computing unit 545 or a MEC server device, and a terminal device 550, in examples of the present disclosure, a description about a base station, a server and a terminal may be equally applied and an overlapping description is omitted.

FIG. 6 is a graph representing energy consumption according to the number of terminals in a synchronous and asynchronous MEC system.

FIG. 7 is a graph representing energy consumption according to a task size to be processed in a synchronous and asynchronous MEC system.

In FIG. 6 and FIG. 7, a result according to an asynchronous method according to the present disclosure is indicated as “Async” and a result according to a synchronous method in contrast with the present disclosure is indicated as “Sync”.

In an example of FIG. 6 and FIG. 7, it is assumed that the total frequency bandwidth BW is 10 MHz, noise power σ² is −174 dBm/Hz, the maximum transmit power of a terminal P_{D} is 35 dBm, the maximum transmit power of a base station P_{D} is 40 dBm, reference pathloss at a distance of 1 m G is −60 dB, a pathloss index θ is 3.5, the maximum allowable clock frequency of a terminal f_{L,max} is 2×10⁹, the maximum allowable clock frequency of a server f_{S,max} is 5×10¹⁰, an effective capacitance constant of a terminal K_{L} is 10⁻²⁷, an effective capacitance constant of a server K_{S} is 10⁻²⁹, the number of cycles per bit required to process an input bit of a server C is 103, and a calculation result change rate η is 0.5.

Looking at a simulation results of FIG. 6 and FIG. 7, it may be seen that an asynchronous MEC system according to the present disclosure always consumes less energy than a synchronous MEC system.

As such, according to data partial offloading processing of a plurality of terminals based on an asynchronous resource allocation method of a MEC system according to the present disclosure, a communication resource and a computing resource which are wasted without being used in a synchronous resource allocation and computing method may be fully utilized through an asynchronous method, so energy consumption of the entire system may be reduced by efficiently allocating a communications and computing resource.

According to an asynchronous resource allocation method of a MEC system, an invention according to the present disclosure may contribute to increasing survival time by efficiently managing energy of IoT terminals which are explosively increasing in a 5G ecosystem.

Illustrative methods of the present disclosure are expressed as motion series for clarity of a description, but it is not to limit an order that a step is performed and if necessary, each step may be performed simultaneously or in a different order. To implement a method according to the present disclosure, other step may be additionally included in an illustrated step, or remaining steps except for some steps may be included, or an additional other step except for some steps may be included.

A variety of embodiments of the present disclosure do not enumerate all possible combinations, but are to describe a representative aspect of the present disclosure, and matters described in various embodiments may be independently applied or may be applied by at least two combinations.

In addition, a variety of embodiments of the present disclosure may be implemented by a hardware, a firmware, a software, or their combination, etc. For implementation by a hardware, implementation may be performed by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

A scope of the present disclosure includes software or machine-executable commands (e.g., an operating system, an application, a firmware, a program, etc.) which execute an action according to a method of various embodiments in a device or a computer and a non-transitory computer-readable medium that such software or commands, etc. are stored and are executable in a device or a computer.

### INDUSTRIAL APPLICABILITY

The present disclosure may be applied to a variety of computing systems.

1. An asynchronous resource allocation method in a base station of a mobile edge computing (MEC) system, the asynchronous resource allocation method comprising:
determining an optimal value of a predetermined variable for minimizing consumption energy of the MEC system for a predetermined time duration by using basic information on each of the base station, a server and at least one terminal;
transmitting configuration information on the optimal value to each of the server and the at least one terminal; and
allocating a resource for each of the base station, the server and the at least one terminal based on the optimal value,
wherein the predetermined variable includes at least one of transmit power variable P, resource allocation ratio variable W, time duration length variable T, and offload-residual data partition variable O.

2. The method according to claim 1, wherein the asynchronous resource allocation method comprising:
allocating a communication resource and a computing resource so that at least two of uplink transmission from the at least one terminal to the base station, offload data computing of the server, downlink transmission from the base station to the at least one terminal, residual data computing of the at least one terminal are performed simultaneously.

3. The method according to claim 1, wherein determining the optimal value comprising:
deriving the consumption energy as a non-convex function, and approximating the non-convex function to a convex or concave function.

4. The method according to claim 3, wherein determining the optimal value comprising:
repeatedly solving the approximated convex or concave function after initializing the predetermined variable.

5. The method according to claim 4, wherein determining the optimal value comprising:
approximating the non-convex function to the convex or concave function based on a temporary optimal value obtained in previous repetition.

6. The method according to claim 5, wherein:
the optimal value is determined as the optimal value when the approximated convex or concave function converges.

7. The method according to claim 1, wherein:
the predetermined time duration is defined as T, a maximum allowable delay time length for processing completion of a task of k terminals,
T is partitioned into K+2 time durations,
consumption energy for the predetermined time duration is determined based on consumption energy in each of the K+2 time durations.

8. The method according to claim 7, wherein:
ζᵤₛₑᵣ, energy consumed for uplink transmission and residual data processing of the K terminals for the K+2 time durations, is defined by the following Equation,
$${ζ}_{user} = {\sum }_{k = 1}^{K} {E}_{L , k} + {\sum }_{k = 1}^{K} {\sum }_{n = 1}^{k} t [ n ] {p}_{k} [ n ]$$
where, k is each index of the K terminals,
E_{L,k} is energy consumed for residual data processing of a k-th terminal,
t[n] is a length of a n (n=1, 2, 3, . . . , K+2)-th time duration among the K+2 time durations,
pₖ[n] is uplink transmit power in a n-th time duration of the k-th terminal.

9. The method according to claim 8, wherein:
ζ_{BS}, energy consumed for downlink transmission and offload data processing of the K terminals for the K+2 time durations, is defined by the following Equation,
$${ζ}_{BS} = {\sum }_{k = 1}^{K} {E}_{S , k} + {\sum }_{k = 1}^{K} {\sum }_{n = k + 2}^{K + 2} t [ n ] {q}_{k} [ n ]$$
where, E_{S,k} is energy consumed for offload data processing of the k-th terminal in the server,
qₖ[n] is downlink transmit power in the n-th time duration for the k-th terminal of the base station.

10. The method according to claim 9, wherein:
consumption energy minimization of the MEC system is defined by the following Equation,
$$\begin{matrix}( P ) \begin{matrix}min \\ P , W , T , O\end{matrix} {w}_{1} {ζ}_{u s e r} + {w}_{2} {ζ}_{B S} \\ \begin{matrix}s . t . & {\sum }_{n = 1}^{K + 2} t [ n ] \leq T , α [ n ] + β [ n ] = 1 , ∀ n\end{matrix} \end{matrix} \qquad ( 1 )$$
$${p}_{k [ n ]} \leq {P}_{U} , ∀ k , n , {{\sum }_{k = 1}}^{K} {q}_{k} [ n ] \leq {P}_{D} , ∀ n \qquad ( 2 )$$
$$\begin{matrix}{Cl}_{S , k} \leq t [ k + 1 ] {f}_{S , max} , & {Cl}_{L , k} \leq {Tf}_{L , max} , ∀ k\end{matrix} \qquad ( 3 )$$
$${\sum }_{n = 1}^{k} {I}_{U , k} [ n ] \geq {l}_{S , k} , {\sum }_{n = k + 2}^{K + 2} {I}_{D , k} [ n ] \geq η {l}_{S , k} , ∀ k \qquad ( 4 )$$
where, w₁ is a portion occupied by consumption energy of the k terminals in consumption energy of the MEC system,
w₂ is the portion occupied by consumption energy of the base station and the server in consumption energy of the MEC system,
α[n] is an uplink resource allocation ratio in the n-th time duration,
β[n] is a downlink resource allocation ratio in the n-th time duration,
P_{U} is uplink maximum transmit power,
P_{D} is downlink maximum transmit power,
C is a number of cycles per bit of the server,
l_{S,k} is an offload data size of the k-th terminal,
f_{S,k} is a clock frequency of the server required for calculation of l_{S,k} bits,
l_{L,k} is a residual data size of the k-th terminal,
f_{L,k} is the clock frequency of the k-th terminal required for calculation of l_{L,k} bits,
I_{U,k}[n] is an uplink transmission data size in the n-th time duration,
I_{D,k}[n] is a downlink transmission data size in the n-th time duration,
η is a calculation result change rate in the server.

11. The method according to claim 10, wherein:
the transmit power variable P is defined by
P [symbol] {pₖ[n],qₖ[n],∀k,n},
the resource allocation ratio variable W is defined by
W [symbol] {α[n],β[n],∀n},
the duration length variable T is defined by T [symbol] {t[n], ∀n},
the offload-residual data partition variable O is defined by
O [symbol] {l_{L,k},l_{S,k},∀k}.

12. The method according to claim 11, wherein:
an approximated convex or concave function of the equation for minimizing consumption energy of the MEC system is defined by the following equation,
$$( P ) \begin{matrix}min \\ E , A , T , O\end{matrix} {w}_{1} {ζ}_{u s e r} + {w}_{2} {ζ}_{B S}$$
$$s . t . {\sum }_{n = 1}^{K + 2} t [ n ] \leq T , A [ n ] + B [ n ] = t [ n ] , ∀ n ,$$
$${E}_{U , k} [ n ] \leq t [ n ] {P}_{U} , ∀ k , n , \qquad {E}_{D , k} [ n ] \leq t [ n ] {P}_{D} , ∀ n$$
$$C {l}_{S , k} \leq t [ k + 1 ] {f}_{S , max} , \qquad {Cl}_{L , k} \leq {Tf}_{L , max} , ∀ k$$
$${\sum }_{n = 1}^{k} {\hat{I}}_{U , k}^{( m )} [ n ] \geq {l}_{S , k} , {\sum }_{n = k + 2}^{K + 2} {\hat{I}}_{D , k}^{( m )} [ n ] \geq η {l}_{S , k} , ∀ k$$
where, E is an uplink and downlink transmission consumption energy variable,
A is an uplink and downlink use resource variable,
Î_{U,k}^{(m)}[n] is a surrogate lower limit function of the uplink transmission data size I_{U,k}[n] in m-th repetition,
Î_{D,k}^{(m)}[n] is the surrogate lower limit function of the downlink transmission data size I_{D,k}[n] in m-th repetition.

13. The method according to claim 12, wherein:
the uplink and downlink transmission consumption energy variable E is defined by E [symbol] {E_{U,k}[n], E_{D,k}[n], ∀k,n},
the uplink and downlink use resource variable A is defined by
A [symbol] {A[n],B[n],∀n}.

14. The method according to claim 13, wherein: the Î_{U,k}^{(m)}[n] and the Î_{D,k}^{(m)}[n] satisfy the following equation,
I_{U,k}^{(m)}[n]≥Î_{U,k}^{(m)}[n] [symbol] BW(f(A^{(m)}[n],J_{U,k}^{(m)}[n])−g(A^{(m)}[n],J_{U,k-1}^{(m)}[n]|A^{(m-1)}[n],J_{U,k-1}^{(m-1)}[n]))
I_{D,k}^{(m)}[n]≥Î_{D,k}^{(m)}[n] [symbol] BW(f(B^{(m)}[n],J_{D,k}^{(m)}[n])−g(B^{(m)}[n],J_{D,k+1}^{(m)}[n]|B^{(m-1)}[n],J_{D,k+1}^{(m-1)}[n])) [Equation 15]
where, f(x,y), g(x,y) is defined by the following equation,
$$f ( x , y ) {=}^{Δ} x {log}_{2} ( 1 + \frac{y}{x} )$$
$$g ( x , y \vert \tilde{x} , \tilde{y} ) {=}^{Δ} x {log}_{2} ( 1 + \frac{\tilde{y}}{\tilde{x}} ) - \frac{{log}_{2} e}{\tilde{x} + \tilde{y}} ( x \tilde{y} - \tilde{x} y )$$
where, J_{U,k}^{(m)} [n] and J_{D,k}^{(m)}[n] are defined by the following equation,
$$\begin{matrix}{J}_{U , k}^{( m )} [ n ] {=}^{Δ} {\sum }_{i = n}^{k} {E}_{U , i}^{( m )} [ n ] {γ}_{i} \\ {J}_{D , k}^{( m )} [ n ] {=}^{Δ} {γ}_{k} {\sum }_{i = k}^{n - 2} {E}_{D , i}^{( m )} [ n ]\end{matrix} .$$

15. A base station device performing asynchronous resource allocation in a mobile edge computing (MEC) system, an asynchronous resource allocation base station device comprising:
a transceiver;
a memory; and
a processor,
wherein the processor is configured to:
determine an optimal value of a predetermined variable for minimizing consumption energy of the MEC system for a predetermined time duration by using basic information on each of the base station, a server and at least one terminal stored in the memory;
transmit configuration information on the optimal value to each of the server and the at least one terminal through the transceiver; and
allocate a resource for each of the base station, the server and the at least one terminal based on the optimal value,
wherein the predetermined variable includes at least one of transmit power variable P, resource allocation ratio variable W, time duration length variable T, and offload-residual data partition variable O.
